(19) United States
(12) Patent Application Publication
(10) Pub. No.: US 2009/0259617 A1
(43) Pub. Date: Oct. 15, 2009

(54) Method And System For Data Management

(76) Inventors: Richard Charles Cownie, Brookline, MA (US); Chandra Prakash Jain, Noida (IN); Somnath Banerjee, Asansol (IN); Tushar Gupta, Noida (IN)

Correspondence Address: MENTOR GRAPHICS CORP.;PATENT GROUP, 8005 SW BOECKMAN ROAD, WILSONVILLE, OR, 97070-7777, US

(21) Appl. No.: 12/103,574

(22) Filed: Apr. 15, 2008

(51) Int. Cl. G06F 17/30

(52) U.S. Cl. 707/2; 707/E17.002

(57) ABSTRACT

The invention provides a method, a system and a computer program product for managing the data of Electronic Design Automation (EDA) tools in data processing units. This data is managed by a database management system. Data entries that are added to a database are sorted, compressed and stored. These data entries can be easily retrieved from the database that is based on a retrieval key.

### FIELD OF THE INVENTION

The present invention relates generally to the field of databases. More specifically, various implementations of the invention relate to a method for managing large databases with data pertaining to Electronic Design Automation (EDA) tools and applications.

### BACKGROUND OF THE INVENTION

Data processing units are used to manage data entries in a database. Examples of a data processing unit include a mainframe computer, a personal computer, a laptop, a Personal Digital Assistant (PDA), a mobile phone, or the like or the like. Examples of a database in EDA applications include a netlist, a schematic, a hardware design language file, a circuit design, a physical layout data file, and a mask preparation data file, and many more EDA schema files and filesets. EDA tools, in particular, generate and use large databases that must be accessed and manipulated efficiently. For example, the design of an Integrated Circuit (IC) may include several million transistors that require millions of polygons to be defined to write to a mask for fabricating the IC. In some steps in the process, each polygon is fragmented and defined by its edges, and every polygon fragment is run through a rule-checking algorithm to verify its correctness. Further, mapping data is required across different levels of design abstraction, for the fabrication and verification of the IC.

The database is generally managed on these data processing units by using a database management system, which enables other applications to access the database. Examples of database management systems include Oracle®, DB2®, Microsoft® SQL Server, MySQL®, Berkeley Database Management System (BDMS), or the like or the like. Examples of applications include computer-aided design software such as simulators, place and route tools, logical and physical verification software, optical process and correction tools, hardware assisted verification tools such as emulators and accelerators, or the like or the like.

The applications process the data entries in the database. The performance of an EDA application depends largely on the speed at which the application can access data entries from the database. The database-management system can enhance the performance of the application by providing quick access to the data entries.

In recent years, circuit designs, and hence circuit-design databases have increased exponentially in size. This gives rise to problems in accessing and storing data in the database. As the size of the database increases, it gets fragmented, which results in clustering and uneven distribution of data. Consequently, there is an increase in memory usage, with the data-access time increasing significantly and affecting the performance of the application.

There is, therefore, a desire for a database management system that requires a short access time to retrieve data from the database. Further, there is a desire for a database management system that can store large databases in an organized manner and consumes less memory than conventional databases.

### SUMMARY OF THE INVENTION

Aspects of the present invention relate to improving storage, retrieval and data manipulation in large databases, and to reducing application run times.

Additional aspects of the invention are directed towards achieving reduced application run times with almost negligible fragmentation in the database.

Still further aspects of the invention seek to make the database scalable, so that larger design sizes can be realized without there being a linear regressive impact on the database access time.

Various embodiments of the invention provide a method, a system and a computer program product for managing databases stored in data processing units. The data entries to be stored in the database are temporarily stored in buffer files, which are later sort-merged into logical containers. The logical containers are contiguously stored in a datafile in the database by means of a file interface. References to each logical container are also maintained in a reference file in the database. The database can be maintained on the data processing unit, or can be stored over the network. The data entries can be readily accessed from the database by using the data blocks of the datafile and the logical containers.

These and additional aspects of the invention will be further understood from the following detailed disclosure of illustrative embodiments.

### BRIEF DESCRIPTION OF THE DRAWINGS

The preferred embodiments of the invention will hereinafter be described in conjunction with the appended drawings, provided to illustrate and not to limit the invention, wherein like designations denote like elements, and in which:

FIG. 1 is a block diagram of an environment, in which various embodiments of the invention may be practiced;

FIG. 2 is a block diagram of data processing units, in accordance with at least one embodiment of the invention;

FIG. 3 is a block diagram depicting the structure of a database, in accordance with at least one embodiment of the invention;

FIG. 4 is a block diagram of a database management system, in accordance with at least one embodiment of the invention;

FIG. 5 is a flowchart depicting a method for managing a plurality of data entries, in accordance with at least one embodiment of the invention;

FIG. 6 is a flowchart depicting a method for managing the plurality of data entries, in accordance with at least one embodiment of the invention;

FIG. 7 is a flowchart depicting a method for retrieving one or more data entries from the database, in accordance with at least one embodiment of the invention; and

FIG. 8 is a flowchart depicting a method for deleting data entries from buffer files, in accordance with at least one embodiment of the invention.

### DETAILED DESCRIPTION OF THE ILLUSTRATIVE EMBODIMENTS

Various embodiments of the invention provide a method, a system and a computer program product for managing the data entries of Electronic Design Automation (EDA) tools on data processing units. These data processing units may be connected to each other in a network. Data entries are sorted and compressed and maintained in a database on these data processing units. The data entries can be stored, accessed or deleted from the database through the network.

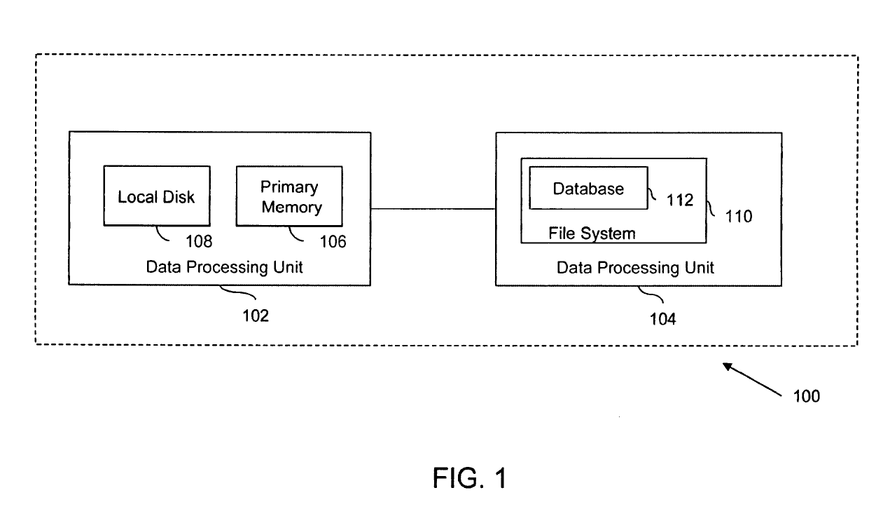

FIG. 1 is a block diagram of an environment 100, in which various embodiments of the invention may be practiced. The environment 100 includes a data processing unit 102 and a data processing unit 104 that are connected in a network. The data processing unit 102 includes a primary memory 106 and a local disk 108. The data processing unit 104 includes a file system 110, which stores a database 112.

The data processing unit 102 contains a data management system that manages the generation of the database 112, which includes the generation and updating of the database 112 and the retrieval of various data entries from the database 112. The data processing unit 102 accepts the data-entry inputs through the primary memory 106. The primary memory 106 acts as a temporary data-storage unit on the data processing unit 102, and is used to perform various operations on data entries that need to be added to or accessed from the database 112. In various embodiments of the invention, primary memory 106 is a Random Access Memory (RAM) module.

The data entries are initially added to a buffer file in the primary memory 106, and are sorted in the buffer file. After a predetermined number of data entries are added to the buffer file, the buffer file is moved to the local disk 108 for temporary storage. In various embodiments of the invention, the local disk 108 may be a hard disk, a floppy disk, a compact disk, a digital video disk, or the like. Various buffer files are sorted and merged in the primary memory 106, to form logical containers. These logical containers are temporarily stored in the cache of the primary memory 106, and are thereafter moved to the file system 110, to be stored in the database 112 in the form of a datafile.

In various embodiments of the invention, the data entries are attributes such as the annotation and hardware location of the hierarchical names in an electronic design. The hierarchical names may be Register Transfer Level (RTL) names. The hierarchical names may describe a state signal, a memory signal, a clock signal, a combinational element, or the like. Additionally, the hierarchical names may describe which users perform various operations such as waveform viewing, memory-content download; the upload, register set and get operations, or the like.

The data processing unit 104 includes the file system 110, which provides memory for maintaining the database 112 and enables the database 112 to be accessed by the data processing unit 102 or the like, through the network. The file system 110 contains a file interface for storing and retrieving various data entries from the datafile in the database 112. In various embodiments of the invention, the file system 110 may be the Network File System (NFS), the Andrew File System (AFS), the Common Internet File System (CIFS), or the like.

In various embodiments of the invention, the database 112 is an organized way of storing and maintaining netlists, schematics, hardware-design language files, circuit designs, physical layout data, mask-preparation data, other EDA schema files and file sets, or the like. In an embodiment of the invention, the database 112 can be used to store hierarchical names; name attributes; state elements; un-optimized combinational signals; mapping from hierarchical names; name attributes to hardware location; mapping of memory instances in the design to the address, data range and initial contents; mapping of clock signals to clock generation in hardware; mapping of hierarchical names to their annotation, or the like.

With various embodiments of the invention, the data processing units 102 and 104 may be a mainframe computer, a personal computer, a laptop, a Personal Digital Assistant (PDA), or the like.

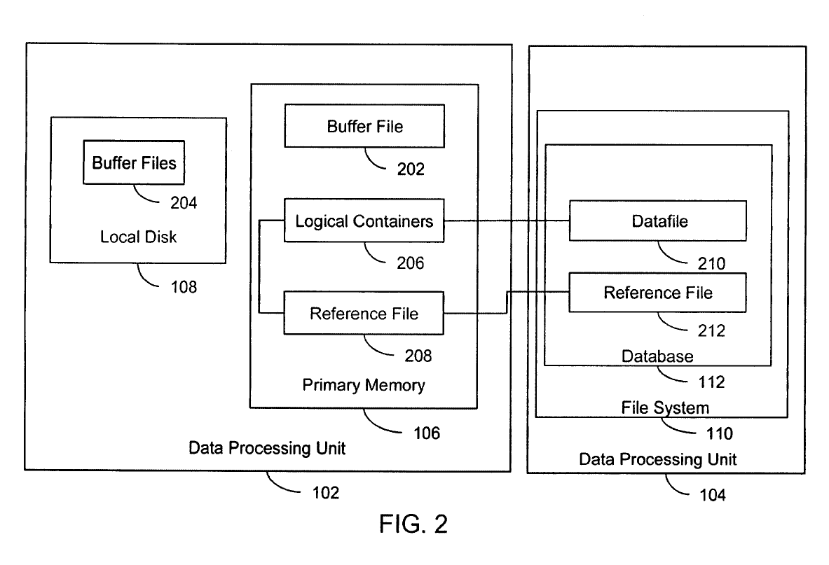

FIG. 2 is a block diagram of the data processing units 102 and 104, in accordance with various embodiments of the invention. The data processing unit 102 includes the primary memory 106 and the local disk 108. The primary memory 106 includes a buffer file 202, a logical container 206, and a reference file 208. The local disk 108 includes buffer files 204. The data processing unit 104 includes the file system 110, which includes the database 112, which further includes a datafile 210 and a reference file 212.

The buffer file 202, the buffer files 204 and the logical containers 206 are used to store one or more data entries. Each data entry received through the data processing unit 102 that is to be stored in the database 112 includes a key and one or more values. The reference file 208 includes various references that refer to the logical container 206 and the data entries stored in the logical container 206.

The buffer file 202 is used to store and sort a predefined number of data entries that are to be stored in the database 112. The predefined number of data entries to be entered in the database 112 are initially added to the buffer file 202 in the primary memory 106.

In various embodiments of the invention, once the predefined number of data entries are added to the buffer file 202, they are sorted in the primary memory 106 and moved to the local disk 108, to be stored in the form of a buffer file 204. Thereafter, a new buffer file 202 is formed in the primary memory 106, to store future data entries.

In various embodiments of the invention, the data entries can be entered in the buffer file 202 in a sorted manner. Therefore, the buffer file 202 need not be sorted. The buffer files 204 present on the local disk 108 contain a number of the buffer files 202 that were moved from the primary memory 106 to the local disk 108 for temporary storage. Each of the buffer files 202 may containing the predefined number of sorted data entries. In various embodiments of the invention, the buffer files 204 are compressed while being stored on the local disk 108.

The logical container 206 includes data entries in the form in which they are required to be stored in the database 112 and are formed by sort-merging the buffer files 204. The buffer file 202 is sorted after the last data entry to be stored in the database 112 has been added to the newly formed buffer file 202. Thereafter, data entries from the buffer files 204 stored on the local disk 108 are moved to the primary memory 106, to be sort-merged into a logical container 206 of a predefined length. In various embodiments of the invention, the lowest data entry may be taken from the buffer file 202 and from each of the buffer files 204 at one time in the primary memory 106 in the form of a data structure, such as a priority queue, and are sorted to be stored into the logical container 206. In this manner, the buffer files 204 and the buffer file 202 are sort-merged into various logical containers that are stored in the datafile 210 of the database 112 in the form of datablocks. With various embodiments of the invention, the data entries to be stored in the database 112 are sorted across different logical containers.

The reference file 208 has various references to a logical container. In various embodiments of the invention, these references include some reference keys of the logical container 206, the position and size of the logical container 206 in the datafile 210, or the like. In some embodiments of the invention, the reference keys are the first and the last key of the data entries in each of the logical containers 206 stored in the datafile 210. References are added to the reference file 208 when the logical container 206 is moved to the database 112.

In various embodiments of the invention, the reference file 208 is compressed and thereafter stored in the reference file 212 in the database 112 with the datafile 210. Additionally, with various embodiments of the invention, the reference file 208 is loaded into the primary memory 106 for retrieval of data entries from the database 112.

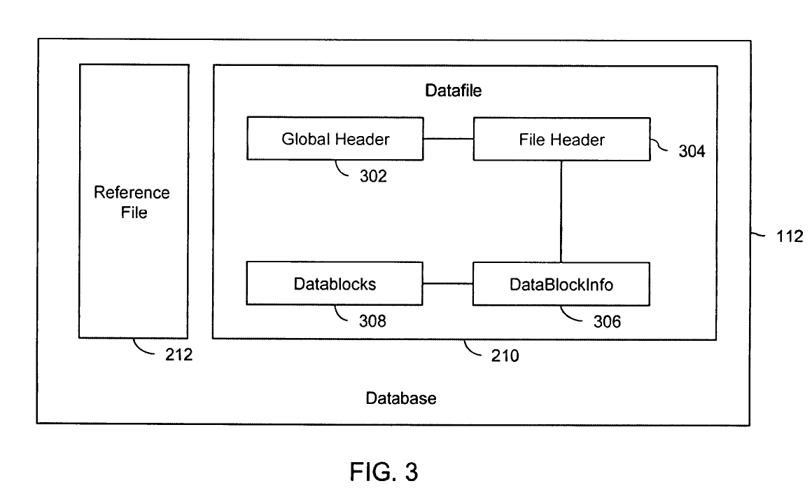

FIG. 3 is a block diagram depicting the structure of the database 112, in accordance with at least one embodiment of the invention. The database 112 includes the datafile 210 and the reference file 212. The datafile 210 includes a global header 302, a file header 304, a plurality of DataBlockInfo 306 and a plurality of datablocks 308.

In various embodiment of the invention, the file system 110 is used to store data in the database 112 that is maintained on the data processing unit 104. The file system 110 stores various logical containers sequentially in the datafile 210 that comprise various sub-files, and the references to these logical containers in the reference file 212. These sub-files are stored in the form of a datablock or datablocks 308 in the database 112. The datablocks 308 store sub-files in a page-wise manner, with each page having a fixed width. The datablocks 308 can be accessed through the DataBlockInfo 306, which is accessed through the file header 304. The file header 304 corresponds to the sub-files and stores information pertaining to each sub-file. The file header 304 can be accessed through the global header 302, which corresponds to the datafile 210 and stores information relating to it.

The global header 302 enables access to the datafile 210 stored in the database 112. In various embodiments of the invention, the global header 302 may include information pertaining to the type of compression used to compress the datafile 210, references to the various file headers 304, or the like. The global header 302 is loaded into the primary memory 106 of the data processing unit 102 at the time of data retrieval from the database 112.

In various embodiments of the invention, information pertaining to the type of compression used to compress the datafile 210 may include the name of the compression technique used, a code to compress or uncompress the datafile 210, a compression algorithm used to compress it, or the like. Further, information relating to the sub-files stored in the datafile 210 may include the position of the file header 304, the name of the sub-files referred to by the file header 304, the properties of the file header 304, or the like.

In some embodiments of the invention, the global header 302 is stored in the database 112 in an uncompressed manner. Alternatively with other embodiments of the invention, the global header 302 is stored in the database 112 in a compressed manner.

The file header 304 enables access to a sub-file stored in the datafile 210. In some embodiments of the invention, the file header 304 stores reference information pertaining to the DataBlockInfo 306, such as the name of the subfile, the position of the DataBlockInfo 306, the properties of the DataBlockInfo 306, or the like. With some embodiments of the invention, the file header 304 is stored in the database 112 in an uncompressed manner. Alternatively, in other embodiments of the invention, the file header 304 is stored in the database 112 in a compressed manner.

The DataBlockInfo 306 enables access to the datablocks 308. In various embodiments of the invention, the DataBlockInfo 306 stores the position of the datablocks 308, the compressed block length of the datablocks 308, and the references to the datablocks 308. With various embodiments of the invention, the references to the datablocks 308 encode the index of the datafile 210 that is present in the datablocks 308 and the offset of the datablocks 308 in the datafile 210.

In various embodiments of the invention the datablocks 308 include the data entries stored in the database 112. The datablocks 308 may be used to divide the datafile 210 logically. The logical division of the datafile 210 into the datablocks 308 enables the storage and retrieval of the datafile 210 stored in the database 112. In various embodiments of the invention, each of the datablocks 308 stores more than one sub-file. With still other embodiments of the invention, each of the datablocks 308 stores a part of a sub-file.

In various embodiments of the invention, the logical container 206 is compressed and then moved to the database 112 and stored in the datablocks 308. In at least one embodiment of the invention, the logical container 206 is cached in the primary memory 106 and is moved to the datablocks 308 with other logical containers once they reach the size of a datablock. In still other embodiments of the invention, the logical container 206 is moved to the datablocks 308 as soon as its formation in the primary memory 106 is complete.

In at least one embodiment of the invention, the size of the datablocks 308 is fixed. In other embodiments of the invention, the size of the datablocks 308 may be based on the size of the datafile 210 and associated sub-files, the compression schemes used, the size of the memory unit 402, or the like.

In various embodiments of the invention, the datablocks 308 are compressed, leaving some empty space, which enables the addition of data entries. The modified datablock can be stored at the original location if the storage space allocated for the datablock is enough. Further, a list of empty datablock locations is maintained to store the modified datablocks that cannot be stored at their original locations.

The reference file 212 includes the references of the logical containers stored in the datablocks 308. The reference file 208 (shown in FIG. 2) is updated with the references when the logical container 206 is moved to the datablocks 308. Thereafter, the reference file 208, or a portion of the reference file 208, is moved to the reference file 212. In various embodiments of the invention, the reference file 208 is moved to the reference file 212 as soon as it is updated. Alternatively with other embodiments of the invention, the reference file 208 is moved to the reference file 212 after the last logical container 206 has been moved to the datablocks 308. In still other embodiments of the invention, the reference file 208 is moved to the reference file 212 once it reaches the size of a datablock. The storage structure of the reference file 212 is similar to that of the datafile 210, which will be apparent to a person having ordinary skill in the art.

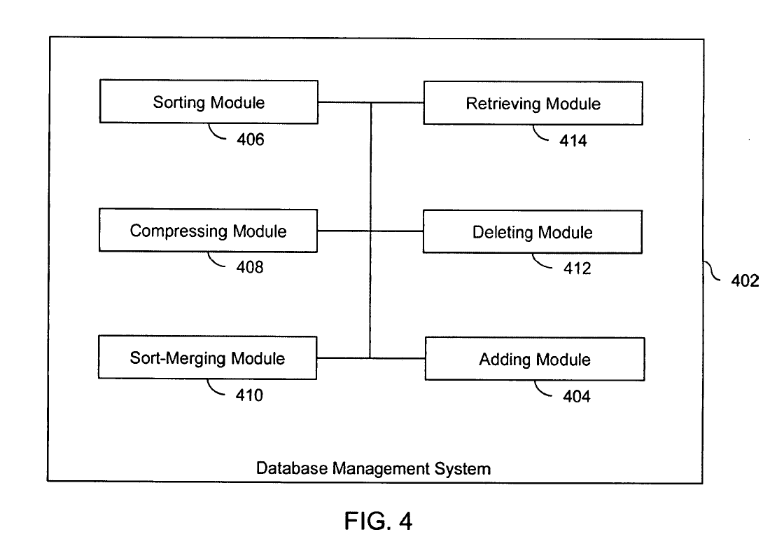

FIG. 4 is a block diagram of a database management system 402, which may be implemented in accordance with various embodiments of the invention. The database management system 402 includes an adding module 404, a sorting module 406, a compressing module 408, a sort-merging module 410, a retrieving module 414, and a deleting module 412. In various embodiments of the invention, the database management system 402 is present on the local disk 108 of the data processing unit 102.

The adding module 404 sequentially adds the data entries into the buffer file 202 in the primary memory 106 up to a predefined number. Once the buffer file 202 is filled, it is moved to the local disk 108 to be a part of the buffer files 204, and the adding module 404 starts adding the data entries to a newly formed buffer file 202 in the primary memory 106.

The sorting module 406 sorts the data entries present in the buffer file 202. In various embodiments of the invention, the sorting module 406 sorts the data entries present in the buffer file 202 in an ascending order, a descending order, an order based on the priority of the data entries in buffer file 202, or the like. Additionally, the sorting module 406 may sort the data entries in the buffer file 202 by using a bubble-sort algorithm, a selection-sort algorithm, an insertion-sort algorithm, a shell-sort algorithm, a heap-sort algorithm, a quick-sort algorithm, or the like.

The compressing module 408 compresses the buffer file 202 before storing it as a part of the buffer files 204 on the local disk 108. Further, the compressing module 408 compresses the logical container 206 and the reference file 208 before moving them to the database 112. In various embodiments of the invention, the compression technique used by the compressing module 408 to compress the buffer file 202, the logical container 206 and the reference file 208 is based on the data type and features of the data entries present in the files. In at least one embodiment of the invention, the compressing module 408 compresses the files by using the LZO compression technique. Alternatively, in various embodiments of the invention, the compressing module 408 compresses the files by using the ZLIB compression technique.

The sort-merging module 410 sort-merges the buffer files 204 into the logical container 206. The buffer files 204 are copied into the primary memory 106 and sort-merged, resulting in the formation of the logical container 206. In various embodiments of the invention, sort-merging may be performed in the primary memory 106 of the data processing unit 102.

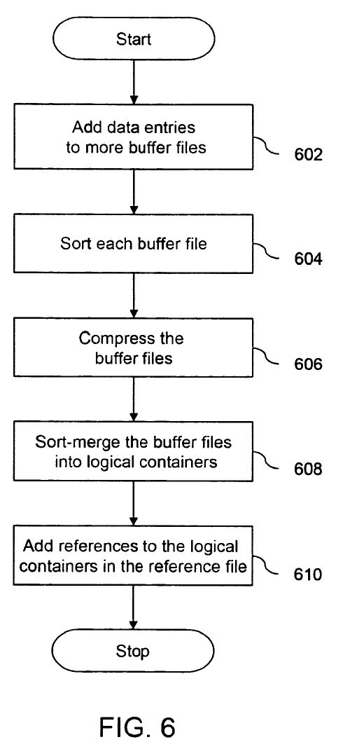

The logical containers 206 are thereafter stored in the database 112 in the form of a datafile 210. The structure of the database 112 has been explained in conjunction with FIG. 3, and sort-merging has been described in detail in conjunction with FIG. 6.

The deleting module 412 deletes one or more data entries before they are stored in the logical containers 206, based on a global list of delete keys. The global list of delete keys in maintained in the primary memory 106, and contains keys corresponding to the data entries that do not need to be stored in the database 112. The deleting module 412 deletes the data entries during sort-merging of the buffer files 204.

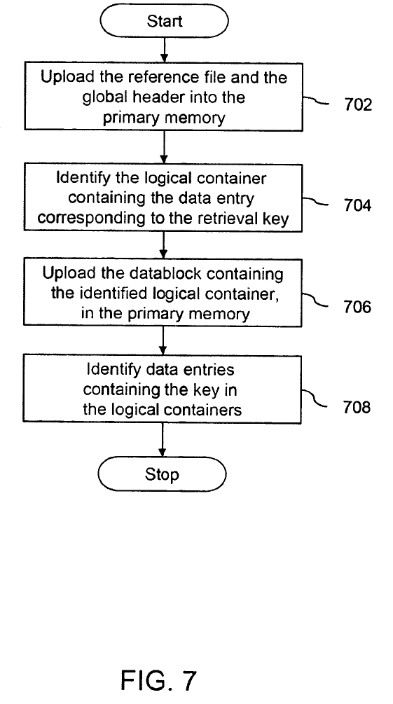

The retrieving module 414 retrieves one or more data entries from the database 112 by using the reference file 212. In various embodiments of the invention, the retrieving module 414 retrieves the data entries from the database 112, based on a retrieval key. The retrieving module 414 identifies a logical container that contains the data entry with the retrieval key, based on the reference file 212, and uploads the corresponding datablock 308, with the logical container 206, into the primary memory 106. This has been explained in further detail in conjunction with FIG. 7.

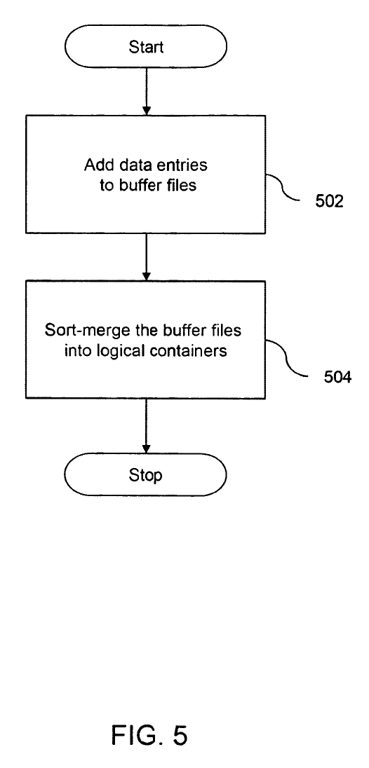

FIG. 5 is a flowchart depicting a method for managing a plurality of data entries, in accordance with various embodiments of the invention. At step 502, the data entries are added to a buffer file present in a primary memory of a data processing unit. In various embodiments of the invention, a predetermined number of data entries are added to the buffer file, and the buffer file is thereafter moved to the local disk of the data processing unit.

With various embodiments of the invention, the predefined number of data entries is based on the size of the data entries and that of the primary memory. The predefined number of data entries indicates the peak memory consumption of the EDA application. In various embodiments of the invention, the predefined number of data entries is obtained by dividing the size of the primary memory of the data processing unit by the representative size of a data entry selected from the plurality of data entries of a buffer file. With still other embodiments of the invention, the predefined number is based on the total number of data entries to be added to the primary memory of the data processing unit.

At step 504, the buffer files are sort-merged into one or more logical containers. These buffer files include the buffer files that have been moved to the local disk as well as the newly formed buffer files in the primary memory. In an embodiment of the invention, the buffer files are sort-merged into the logical containers of a predefined length. In an embodiment of the invention, the lowest data entry can be taken from each buffer file at one time in a priority queue, and sorted to be stored in a logical container. In this manner, the buffer files are sort-merged into various logical containers, which are subsequently moved to the database.

In various embodiment of the invention, the logical containers are stored in a file system that is accessible through the data processing unit. The file system has a file interface that is used to store various logical containers in the database when the database is being formed, and also retrieve the data entries from the database while accessing it.

FIG. 6 is a flowchart depicting a method for managing the plurality of data entries, in accordance with various embodiments of the invention. At step 602, a predetermined number of data entries are added to a buffer file in the primary memory. At step 604, the buffer file is sorted. In an embodiment of the invention, the buffer file may be sorted after being moved to the local disk of the data processing unit. With some embodiment of the invention, the data entries may be added to the buffer file in a sorted manner at step 602. Thereafter, the buffer file does not need to be sorted again.

In various embodiments of the invention, the data entries in the buffer file may be sorted in an ascending order, a descending order, an order based on the priority of the data entries assigned in the buffer file, or the like. Further, the data entries in the buffer file may be sorted by using a bubble-sort algorithm, a selection-sort algorithm, an insertion-sort algorithm, a shell-sort algorithm, a heap-sort algorithm, a quick-sort algorithm, or the like.

At step 606, the buffer file is compressed and then moved to the local disk of the data-processing unit. In various embodiments of the invention, the compression technique used to compress the buffer files is based on the data type of the data entries and the features of the data entries present in the buffer files. In some embodiments of the invention, the LZO compression technique may be used. In other embodiments of the invention, the ZLIB compression technique may be used.

In various embodiments of the invention, the buffer files are not compressed, whereas the datablocks of the database, where the data entries are finally stored, are compressed while being stored in the database. The structure of the datablocks has been described in detail in conjunction with FIG. 3.

At step 608, the buffer files are sort-merged into logical containers in the primary memory of the data processing unit. In various embodiments of the invention, an unsorted array data structure and a priority-queue data structure are used to sort-merge the buffer files. The data structure used to sort-merge the buffer files may be selected based on the number of buffer files, the architecture of the data processing units, the speed of the processor used in the data processing units, the primary memory of the data processing units, or the like. In various embodiments of the invention, a priority queue is preferred over an unsorted array for sort-merging a relatively large number of buffer files. The unsorted array data structure or the priority-queue data structure is formed with the subsequent data entries selected from the buffer files. A key from the data structure is selected, and data entries with keys that are similar to the selected key are merged. This process is performed for all the keys in the data structure. In various embodiments of the invention, the smallest key may be selected from each buffer file. Alternatively in other embodiments of the invention, the largest key may be selected from each buffer file.

In various embodiments of the invention, the logical containers formed after sort-merging are compressed and moved to the file system.

At step 610, references to the logical containers are added to a reference file. In various embodiments of the invention, the references include reference keys, the position and size of each logical container in the datafile, or the like. With some embodiments of the invention, the reference keys are the first and the last key of the logical containers. In various embodiment of the invention, the reference file is compressed and moved to the file system after the references are added to the logical containers. In various embodiments of the invention, the reference file is subsequently moved to the file system after the references are added for each logical container. With still other embodiments of the invention, the reference file is moved to the file system after the references are added for all the logical containers.

FIG. 7 is a flowchart depicting a method for retrieving one or more data entries from the database, in accordance with various embodiments of the invention. The data entries are retrieved from the database, based on a retrieval key. The retrieval key may be a key for which the data entry is required to be retrieved from the database.

At step 702, the reference file and global header are loaded into the primary memory of the data processing unit being used to retrieve the data entries. In various embodiments of the invention, the reference file and the global header are accessed from the file system by using the file interface of the file system. The reference file and the global header are loaded into the primary memory of the data processing unit over the network.

The reference file contains the reference information of the logical containers used to store data entries in the datablocks in the database. The global header, on the other hand, enables access to the datafile stored in the database. The global header includes information pertaining to the type of compression used to compress the datafile, references to the various file headers, or the like.

At step 704, the logical container with the data entry to be retrieved is identified by comparing the retrieval key with the reference information stored in the reference file. In accordance with various embodiments of the invention, references are identified that refer to the logical containers with the retrieval key by performing a search in the reference file uploaded in the primary memory of the data processing unit.

In various embodiments of the invention, a search may be performed by using a binary search algorithm, a linear search algorithm, an interpolation search algorithm, a tree search algorithm, or the like.

At step 706, the datablock with the identified logical container is loaded into the primary memory of the data processing unit. The datablock is accessed by using the file interface of the file system, and is copied to the primary memory to the data processing unit over the network.

The datablock to be loaded may be identified by using the global header that is loaded on to the primary memory.

At step 710, the one or more data entries with the retrieval key are identified in the identified logical container. A search is performed in the identified logical container in the loaded datablock. In various embodiments of the invention, the search may be performed by using a binary search algorithm, a linear search algorithm, an interpolation search algorithm, a tree search algorithm, or the like.

In various embodiments of the invention, the time taken to identify one or more data entries is based on the size of the logical containers. For example, a small logical container has a large number of references, which results in a large reference file. The large reference file takes a longer time to be copied into the primary memory of the data-processing unit. Further, the time taken to identify one or more data entries is based on the distribution of data entries across the one or more logical containers.

In various embodiments of the invention, each datablock has various logical containers. When one datablock is loaded into the primary memory of the data processing unit, various logical containers are cached in the primary memory of the data processing unit in a First In First Out (FIFO) scheme. Various data entries can be retrieved by uploading one datablock into the primary memory and searching in the logical containers contained therein.

The data entries used in a particular EDA application are generally contiguous in nature. Therefore, the data entries that are required sequentially for a particular EDA application are generally found in the same or adjacent logical containers in the same datablock. This enables the retrieval of various data entries without uploading different datablocks.

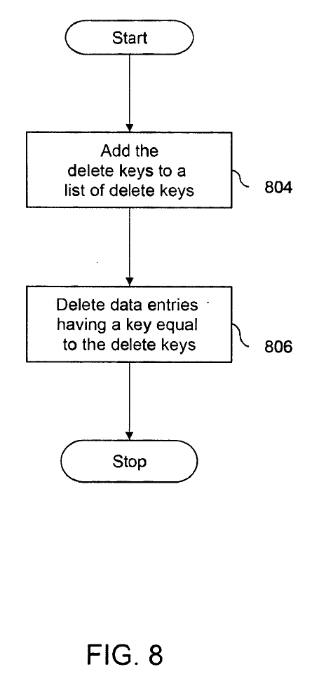

FIG. 8 is a flowchart depicting a method for deleting one or more data entries from the buffer files, in accordance with various embodiments of the invention. These data entries are typically removed from the buffer file before the logical containers are stored in the database.

At step 804, delete keys are added to a list of delete keys. The data entries of these delete keys typically need to be deleted from the buffer files. The list of delete keys may be sorted. In various embodiments of the invention, the delete keys in the list of delete keys may be sorted in an ascending order, a descending order, or an order based on the priority of the delete keys in the list of delete keys. Further, the list of delete keys may be sorted by using a bubble-sort algorithm, a selection-sort algorithm, an insertion-sort algorithm, a shell-sort algorithm, a heap-sort algorithm, and a quick-sort algorithm.

At step 806, data entries are deleted from the buffer files during the sort-merging operation of the data structure, before logical containers are formed. In various embodiments of the invention, data entries with any of the delete keys are deleted. With various embodiments of the invention, data entries are deleted by comparing each sort-merged data entry with the delete keys. The process of deleting the data entries is terminated when the key in the sort-merged data structure becomes larger than the largest delete key in the list of delete keys. With still other embodiments of the invention, the process of deleting the data entries is terminated when the key in the sort-merged buffer files becomes smaller than the smallest delete key in the list of delete keys.

### CONCLUSION

The method, system and computer program product described above have a number of advantages. The system provides quick data-access time to the database. Moreover, the time required to generate the database is reduced. Furthermore, the database occupies less memory space for organizing and maintaining the data entries.

The computer system comprises a computer, an input device, a display unit and the Internet. The computer also comprises a microprocessor, which is connected to a communication bus. Moreover, the computer includes a memory, which may include Random Access Memory (RAM) and Read Only Memory (ROM). Further, the computer system comprises a storage device that can be a hard disk drive or a removable storage drive such as a floppy disk drive, an optical disk drive, etc. The storage device can also be other similar means for loading computer programs or other instructions into the computer system. Furthermore, the computer system includes a communication unit, which enables the computer to connect to other databases and the Internet through an I/O interface. The communication unit enables the transfer and reception of data from other databases and may include a modem, an Ethernet card, or any similar device that enables the computer system to connect to databases and networks such as LAN, MAN, WAN and the Internet. The computer system enables inputs from a user through the input device that is accessible to the system through an I/O interface.

The computer system executes a set of instructions that are stored in one or more storage elements, to process input data. The storage elements may also hold data or other information, as desired, and may be in the form of an information source or a physical memory element present in the processing machine.

The set of instructions may include various commands that instruct the processing machine to perform specific tasks such as the steps that constitute the various implementations of the present invention. The set of instructions may be in the form of a software program. Further, the software may be in the form of a collection of separate programs, a program module with a larger program, or a portion of a program module, as in the present invention. The software may also include modular programming in the form of object-oriented programming. Processing of input data by the processing machine may be in response to user commands, the result of previous processing, or a request made by an alternate processing machine.

While the preferred embodiments of the invention have been illustrated and described, it will be clear that the invention is not limited to these embodiments only. Numerous modifications, changes, variations, substitutions and equivalents will be apparent to those skilled in the art, without departing from the spirit and scope of the invention, as described in the claims.

What is claimed is:

1. A method for managing a plurality of data entries for Electronic Design Automation (EDA) tools in a database on one or more data processing units, each of the plurality of data entries comprising a key and one or more values, the one or more data processing units comprising one or more buffer files, the method comprising:
a. adding the plurality of data entries to the one or more buffer files; and
b. sort-merging the one or more buffer files into one or more logical containers, the one or more logical containers being stored in the database.

2. The method of claim 1 further comprising compressing the one or more buffer files, wherein the one or more buffer files are compressed before the one or more buffer files are sort-merged into the one or more logical containers.

3. The method of claim 1 further comprising deleting one or more data entries from the one or more data processing units based on a list of delete keys, the plurality of data entries being compared with the list of delete keys for deletion during sort-merging the one or more buffer files, the list of delete keys being maintained in the one or more data processing units in a sorted manner.

4. The method of claim 1 further comprising adding one or more references to at least one reference file, the one or more references referring to tie one or more logical containers, wherein the one or more references comprise at least one of one or more keys from the one or more logical containers, size of each of the one or more logical containers, and position of each of the one or more logical containers in the database.

5. The method of claim 4 further comprising retrieving one or more data entries from the one or more logical containers, wherein the retrieval is based on a retrieval key being present in at least one data entry, the retrieving comprising:
a. identifying at least one logical container comprising the retrieval key, the at least one logical container being identified using the one or more references; and
b. identifying at least one data entry present in the at least one logical container.

6. A system for managing a plurality of data entries for Electronic Design Automation (EDA) tools in a database on one or more data processing units, each of the plurality of data entries comprising a key and one or more values, the one or more data processing units comprising one or more buffer files, the system comprising:
a. an adding module, the adding module adding the plurality of data entries to the one or more buffer files; and
b. a sort-merging module, the sort-merging module sort-merging the one or more buffer files into one or more logical containers, the one or more logical containers being stored in the database.

7. The system of claim 6 further comprising a sorting module, the sorting module sorting each of the one or more buffer files.

8. The system of claim 6 further comprising a compressing module, the compressing module compressing the one or more buffer files.

9. The system of claim 6 further comprising a retrieving module, the retrieving module retrieving one or more data entries from the one or more logical containers based on a retrieval key.

10. The system of claim 6 further comprising a deleting module, the deleting module deleting one or more data entries from the data processing unit based one or more delete keys, wherein the one or more delete keys are present in the one or more data entries.

11. A computer program product for use with a computer, the computer program product comprising a computer usable medium having a computer readable program code embodied therein a method for managing a plurality of data entries for Electronic Design Automation (EDA) tools in a database on one or more data processing units, each of the plurality of data entries comprising a key and one or more values, the one or more data processing units comprising one or more buffer files, the computer readable program code performing:
a. adding the plurality of data entries to the one or more buffer files; and
b. sort-merging the one or more buffer files into one or more logical containers, the one or more logical containers being stored in the database.

12. The computer program product of claim 11, wherein the computer readable program code further performs compressing the one or more buffer files, wherein the one or more buffer files are compressed before the one or more buffer files are sort-merged into the one or more logical containers.

13. The computer program product of claim 11, wherein the computer readable program code further performs deleting one or more data entries from the one or more data processing units based on a list of delete keys, the plurality of data entries being compared with the list of delete keys for deletion during sort-merging the one or more buffer files, the list of delete keys being maintained in the one or more data processing units in a sorted manner.

14. The computer program product of claim 11, wherein the computer readable program code further performs adding one or more references to at least one reference file, the one or more references referring to the one or more logical containers, wherein the one or more references comprise at least one of one or more keys from the one or more logical containers, size of each of the one or more logical containers, and position of each of the one or more logical containers in the database.

15. The computer program product of claim 14, wherein the computer readable program code further performs retrieving one or more data entries from the one or more logical containers, wherein the retrieval is based on a retrieval key being present in at least one data entry, the retrieving comprising:
a. identifying at least one logical container comprising the retrieval key, the at least one logical container being identified using the one or more references; and
b. identifying at least one data entry present in the at least one logical container.
